(19) United States
(12) Patent Application Publication
(10) Pub. No.: US 2013/0196708 A1
(43) Pub. Date: Aug. 1, 2013

(54) Propagation of Leveled Key to Neighborhood Network Devices

(71) Applicants: Partha Narasimhan, Saratoga, CA (US); Venkatesh Joshi, Bangalore (IN); Juei-Cheng Lo, Los Altos, CA (US)

(72) Inventors: Partha Narasimhan, Saratoga, CA (US); Venkatesh Joshi, Bangalore (IN); Juei-Cheng Lo, Los Altos, CA (US)

(21) Appl. No.: 13/363,087

(22) Filed: Jan. 31, 2012

(51) Int. Cl. H04W 36/00

(52) U.S. Cl. 455/525

(57) ABSTRACT

The present disclosure discloses a network device and/or method for pro-active propagation of second level security keys (e.g., PMK-R1) to a wireless client's neighboring wireless network devices. The wireless network device derives a first level security key (e.g., PMK-R0) and one or more second level security keys (e.g., PMK-R1) during an initial mobility domain association initiated by the wireless client. Then, the wireless network device determines a subset of wireless network devices in the neighborhood of the wireless client to which it may pro-actively propagate one or more second level security keys corresponding to the wireless client prior to the wireless client initiating a Fast BSS Transition (FT) to any network device in the subset. This would reduce the duration of time that data connectivity is lost between the wireless client and the network during the FT process.

### FIELD

The present disclosure relates to wireless mobile device handoffs in a wireless digital network. In particular, the present disclosure relates to fast Basic Service Set (BSS) transitions (FT) mechanisms between access points in a wireless digital network.

### BACKGROUND

Wireless digital networks, such as networks operating under the current Electrical and Electronics Engineers (IEEE) 802.11 standards, are spreading in their popularity and availability. With such popularity, however, come problems of fast BSS transitions. A BSS transition generally refers to movement of a wireless station from one BSS in one extended service set (ESS) to another BSS within the same ESS. By contrast, a fast BSS transition (FT) generally refers to a BSS transition that establishes the state necessary for data connectivity before the re-association rather than after the re-association.

For example, the current IEEE 802.11i standard (Medium Access Control Security Enhancements) provides pre-authentication and Pairwise Master Key (PMK) caching. Pre-authentication enables supplicants, such as wireless stations, to authenticate with authenticators, such as access points or network controllers, to which they may roam. Pre-authentication typically happens through the access point to which the wireless station is currently associated over a distribution system, such as an Ethernet network. Moreover, PMK caching allows supplicants and authenticators to cache PMK Security Associations (PMKSAs) so that a supplicant revisiting an authenticator to which it has previously authenticated can omit performing IEEE 802.1X/EAP authentications and proceed directly to a 4-way handshake. The 4-way handshake is used by an IEEE 802.1X supplicant and an authenticator to derive Pairwise Transient Keys (PTKs) which are used for encrypting data frames. PMK Caching is also referred to as “fast roam-back” because supplicants have previously authenticated and formed a PMKSA with the authenticator in order to proceed directly to the 4-way handshake.

Alternatively, an Opportunistic Key Caching (OKC) protocol can be used in fast roaming where the supplicant has never authenticated. OKC allows the PMK in the initial PMKSA formed by the supplicant and authenticator to be reused across the network. The PMK can be redistributed by a wireless local area network (WLAN) and given new PMK identifiers that are unique to each access point in the WLAN. The unique PMK identifier may include the new access point's Media Access Control (MAC) address (or BSSID). According to OKC, the supplicant places the unique PMK identifier into its re-association request; and when the authenticator validates the PMK identifier, the access point starts the 4-way handshake using the PMK corresponding to the PMKID to derive a PTK.

Moreover, the current IEEE 802.11r standard (Fast Basic Service Set Transition) specifies an exemplary FT protocol, which redefines a security key negotiation protocol and allows the negotiation and request for wireless resources to occur in parallel. The IEEE 802.11r standard introduces, inter alia, a new 3-tier authentication and key management (AKM) architecture and two tiers of pairwise master keys (PMKs). Furthermore, mobility domain is typically a set of BSSs within the same ESS, each of which is identified by a mobility domain identifier. Fast BSS Transition (FT) can be supported between access points within a mobility domain, but is not specified between mobility domains according to the IEEE 802.11r standard. Also, an authenticator is split into two levels: a first level key holder, such as a PMK-R0 Key Holder (R0KH), and a second level key holder, such as a PMK-R1 Key Holder (R1KH).

Nevertheless, existing protocols supporting fast BSS transitions barely provide any effective and efficient way of propagating leveled security keys to enable the fast BSS transitions. Proactive propagation of leveled security keys from a first level key holder to an appropriate second level key holder can accelerate time required for completion of the fast BSS transition.

### BRIEF DESCRIPTION OF THE DRAWINGS

The present disclosure may be best understood by referring to the following description and accompanying drawings that are used to illustrate embodiments of the present disclosure.

FIG. 1 shows an exemplary wireless network environment according to embodiments of the present disclosure.

FIG. 2 is a block diagram illustrating an exemplary hierarchical security key management scheme used in fast BSS transition according to embodiments of the present disclosure.

FIG. 3A is a sequence diagram illustrating an exemplary communication exchanges during an initial mobility domain association under fast BSS transition according to embodiments of the present disclosure.

FIG. 3B is a sequence diagram illustrating an exemplary communication exchanges during wireless station roaming under fast BSS transition according to embodiments of the present disclosure.

FIGS. 4A-4B are sequence diagrams illustrating exemplary communication exchanges during propagation of leveled security keys under fast BSS transition according to embodiments of the present disclosure.

FIG. 5 is a diagram illustrating an exemplary roaming map according to embodiments of the present disclosure.

FIG. 6 is a flowchart illustrating a process for propagating leveled security key to neighborhood network devices according to embodiments of the present disclosure.

FIG. 7 is a block diagram illustrating a system for propagating leveled security key to neighborhood network devices according to embodiments of the present disclosure.

### DETAILED DESCRIPTION

In the following description, several specific details are presented to provide a thorough understanding. While the context of the disclosure is directed to fast BSS transition mechanisms in wireless network, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to wireless mobile device handoffs in general, and fast BSS transition mechanisms in particular. Specifically, embodiments of the present disclosure propagate one or more leveled security keys to one or more neighborhood network devices prior to a corresponding wireless station roaming to associate with another network device. Such a propagation of leveled security keys can reduce the latency in completion of fast BSS transition for the wireless stations in the network. Also, the disclosed system will reduce the duration of time that data connectivity gets affected during a fast BSS transition, thus provide better support for delay-sensitive applications, for example, live streaming video, voice over Internet Protocol (VoIP), multimedia teleconferencing, etc.

Note that the process of propagation of the leveled security key may be triggered by either a first level key holder or a second level key holder. Also, the neighborhood network devices to which the security key is propagated can be determined either statically by a neighborhood list or dynamically based on a roaming map featuring the roaming pattern of the wireless station, or using a combination of both.

With the solution provided herein, the disclosed network device receives a master key associated with a wireless station (also referred to as “wireless client”) from an authentication server, determines a subset of network devices in the neighborhood of the wireless client, and propagates one or more security keys derived from the master key to the subset of the network devices prior to the wireless client associating with any network device in the subset.

Furthermore, the disclosed network device can perform four-way handshake communication exchanges to derive a derived key for the wireless client, transmit a group temporal key (GTK) to the wireless client, and use the derived key and the GTK in subsequent data transmissions with the wireless client.

In addition, the network device can further derive a first level security key, and transmit the derived first level security key to a first level key holder that stores the first level security key. Likewise, the network device can also derive one or more second level security keys for the wireless client, whereas each second level security key corresponds to one of the network devices in the subset. Moreover, the network device can propagate each second level security key to a corresponding second level key holder in the subset that stores the second level security key. Note that the second level security key is derived based on one or more of the first level security key, a unique identifier associated with the corresponding second level key holder for the network device, and a unique identifier associated with the second level key holder for the wireless client. In one embodiment, the first level security key (or the second level security key) is received by the first level key holder (or second level key holder) during the 4-way handshake communication period.

In some embodiments, propagation of the one or more security keys is initiated by the first level key holder. Specifically, only the first level key holder (and not the second level key holder) will send the second level keys to the second level key holders (e.g., access points in the network). Moreover, one first level key holder can send multiple second level security keys to different second level key holders, where each of the second level key holders will receive a different second level key for the wireless client. Note that the propagation of the one or more security keys is typically initiated by the first level key holder when a neighborhood list or a wireless client roaming map is used to determine the subset of network devices to which the security keys will be propagated.

In some embodiments, propagating the one or more security keys is initiated by the second level key holder in response to receiving a connection request, such as a probe request, an association request, an authentication request, etc., from the wireless client. Note that the second level security key (e.g., PMK-R1) is typically propagated from the first level key holder to the second level key holder. When the propagation happens after the second level key holder (e.g., AP) receives a connection request from the wireless client, the first level key holder will only send the second level key corresponding to the particular second level key holder that initiates the propagation. Hence, only one second level security key will be sent from the first level key holder to the second level key holder(s) in these embodiments.

In some embodiments, the first level security key, the second level security key, and the derived key for the wireless client expire when the master key for the wireless client expires.

In one embodiment, the network device determines the subset of network devices based on whether a network device exists in a neighborhood list indicating closest neighboring network devices to the wireless client. In another embodiment, the network device determines the subset of network devices, where the wireless client is likely to roam to, based on the degree of likelihood indicated on a roaming map of the wireless client. In yet another embodiment, the network device determines the subset of network devices based on a combination of static information (such as a neighborhood list) and dynamic information (such as a roaming map for a wireless client).

### Computing Environment

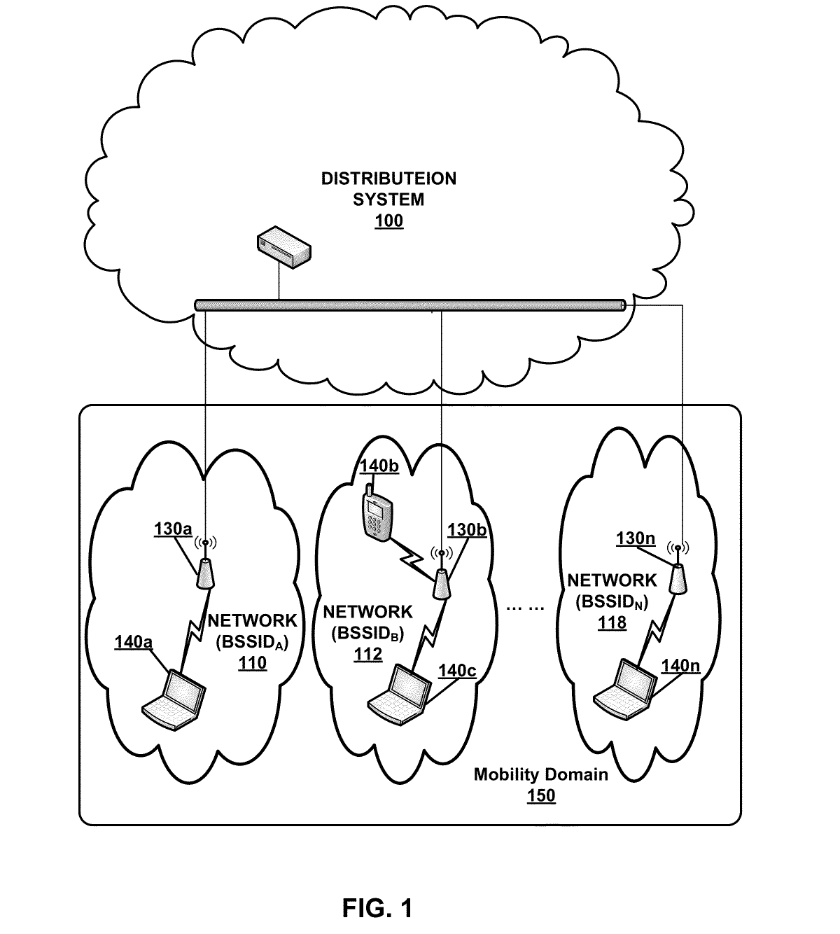

FIG. 1 shows an exemplary wireless digital network environment according to embodiments of the present disclosure. FIG. 1 includes a distribution system 100 coupled to at least one mobility domain 150. In some embodiments, distribution system 100 may be an Ethernet system.

Mobility domain 150 includes a plurality of networks, such as network 110 (with BSSID_{A}), network 112 (with BSSID_{B}), . . . network 118 (with BSSID_{N}). Each network may operate on a private network including one or more local area networks. The local area networks may be adapted to allow wireless access, thereby operating as a wireless local area network (WLAN). In some embodiments, all networks, such as networks 110, 112, 118, and so on, share the same extended service set (ESS) although each network corresponds to a unique basic service set (BSS) identifier.

One or more management network devices, such as an access point, a network controller, a switch, a router, and so on, may be located in network 110, network 112, network 118, or other similar networks, as well as distribution system 100. For example, as illustrated in FIG. 1, network 110 comprises access point 130a and one or more wireless stations including wireless station 140a. Further, network 112 comprises access point 130b and one or more wireless stations including wireless station 140b and wireless station 140c. Likewise, network 118 comprises access point 130n, and one or more wireless stations including wireless station 140n. In some embodiments, network controllers are designated as the first level key holders and access points are designated as the second level key holder.

During operations, a wireless station, such as wireless stations 140a, 140b, 140c, . . . 140n, etc., are associated with their corresponding access points 130a, 130b, . . . 130n, etc. Each wireless station may roam to associate with another access point in the network. Note that although only one mobility domain is depicted in FIG. 1, two or more mobility domains may be included in the system and coupled to distribution system 100 without departing from the spirits of the present disclosure. Thus, the new access point that the wireless station will be associated with may be located within the same mobility domain as or a different mobility domain from the mobility domain corresponding to the access point that the wireless station is currently associated with.

### Hierarchical Security Key Management Scheme

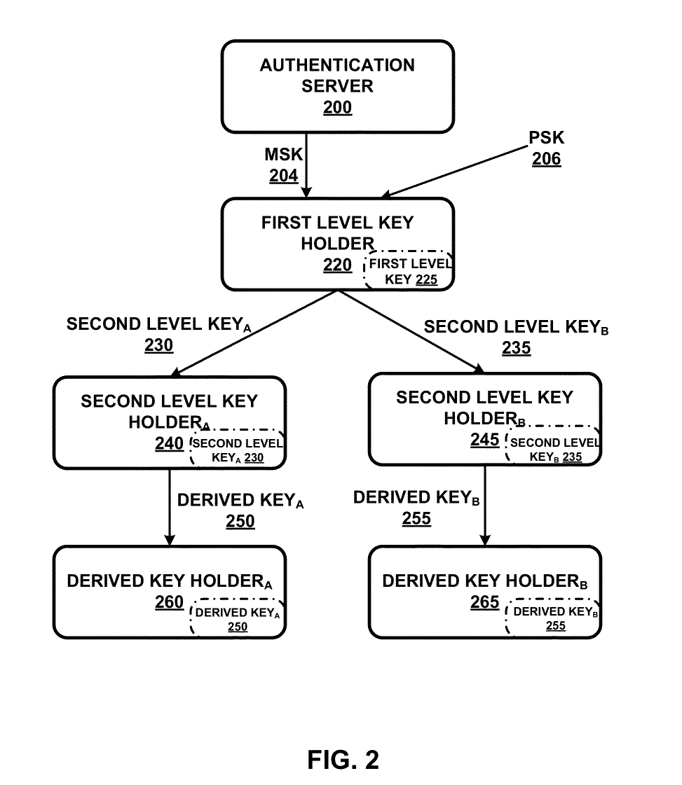

FIG. 2 illustrates an exemplary hierarchical security key management scheme used in fast BSS transition. The hierarchical security key management scheme consists of multiple levels. Each security key holder may be a part of either an access point key management (authenticator key holders) or a station key management (supplicant key holders). In the exemplary three-level security key management scheme depicted in FIG. 2, the fast BSS transition key holder architecture includes at least the first level pairwise master keys (PMK-R0), the second level pairwise master keys (PMK-R1), and the derived security keys (pairwise transient key, PTK).

Moreover, the functions of IEEE 802.1X authenticator are distributed among the first level security key holder 220 (e.g., R0KH for authenticator) and the second level security key holders 240 (e.g., R1KH for authenticator) in each network that is associated with a unique BSSID. The first level security key holder 220 interacts with the IEEE 802.1X authenticator 200 to receive MSK 204 or PSK 206, which results from an Extensible Authentication Protocol (EAP) authentication. The second level security key holder 240 interacts with the IEEE 802.1X authenticator 200 to open a controlled port. IEEE 802.1X standard defines two logical port entities for an authenticated port—the “controlled port” and the “uncontrolled port.” The controlled port is manipulated by the 802.1X Port Access Entity (PAE) to allow or prevent network traffic ingressing to or egressing from the controlled port based on the authorization state. On the other hand, the uncontrolled port is used by the PAE to transmit and receive EAP over LANs (EAPOL) frames.

First level key holder 220 (e.g., R0KH in IEEE 802.11r) stores the first level keys (e.g., PMK-R0 in IEEE 802.11r) for the wireless devices in the network. In some embodiments, a single first level key holder 220 is designated for every wireless client in the same mobility domain. According to some embodiments, first level key 225 (e.g., PMK-R0 in IEEE 802.11r) is unique to each wireless client and remains the same for the wireless client as long as the wireless client is associated with the same mobility domain. In some embodiments, first level key 225 is derived from a master session key (MSK) 204 which is received from authentication server 200 or a pre-shared key (PSK) 206 which is pre-established between the wireless client and the wireless network.

Authentication server 200 can typically be a Remote Authentication Dial-In User Service (RADIUS) server and any other network servers capable of processing Authentication, Authorization, and Accounting (AAA) transactions. MSK 204 is formed at the supplicant and authentication server 200 during an initial association phase, such as the Initial Mobility Domain Association (IMDA) to the authenticator. Moreover, PSK 206 is pre-established between the wireless client and the wireless network.

MSK 204 or PSK 206 is used to derive the first level pairwise master key (e.g., first level key 225 or PMK-R0 under IEEE 802.11r) on both the supplicant and authenticator. Whether MSK 204 or PSK 206 is used to derive first level key 225 is based on the Authentication and Key Management (AKM) suite negotiated by a second level key holder 240 or 245. For example, in some embodiments, if the negotiated AKM is 00-0F-AC:3, then MSK 204 will be used to derive first level key 225 (e.g., PMK-R0); if the negotiated AKM is 00-0F-AC:4, then PSK will be used to derive first level key 225.

Moreover, besides the aforementioned basis for security key derivation, first level security key 225 (e.g., PMK-R0) can also be derived from one or more of the following information:
Service set identifier (SSID);
Length of SSID;
Mobility domain identifier (MDID);
Unique identifier associated with the first level key holder for authenticator (R0KH-ID, e.g., the network controller's MAC address);
Length of unique identifier associated with the first level key holder for authenticator (R0KH-ID);
Unique identifier associated with first level key holder for supplicant (S0KH-ID, e.g., the supplicant's MAC address); and
an input used to derive the first level security key (e.g., FT-R0 under IEEE 802.11r standard).

In some embodiments, the input used to derive the first level security key can be a fixed string input to a one-way hash function, such as a KDF-384 hash function. For example R0-Key-Data may be a hash result that is produced by a hash function performed on any combination of inputs such as XXKey, FT-R0, SSIDlength, SSID, MDID, R0KH-ID, S0KH-ID, etc. More specifically, the first level security key data (which can be used to directly derive the first level security key) can be calculated according to the following formula:

R0-Key-Data=KDF-384 (XXKey, “FT-R0”, SSIDlength∥SSID∥MDID∥R0KH-ID∥S0KH-ID)

In some embodiments, from the first level PMK (e.g., PMK-R0), a set of unique second level PMKs (e.g., PMK-R1s) is derived on the supplicant and the authenticator, whereas each second level PMK (e.g., PMK-R1 under IEEE 802.11r) corresponds to a second level key holder (such as an access point) in the network. The first level key holder (e.g., ROKH under IEEE 802.11r) then distributes, through a mutually-authenticated and confidential connection, each second level PMK (e.g., PMK-R1) to its corresponding second level key holder (e.g., R1KH). In some embodiments, the second level PMK is derived by the first level security key holder for the authenticator (e.g., R0KH) in conjunction with the first level security key holder for the supplicant (e.g., S0KH).

First level key holder 220 derives a second level security key for each second level key holder and client. Specifically, in the example illustrated in FIG. 2, second level key_{A} 230 is derived for a specific client by first level key holder 220 and distributed to second level key holder_{A} 240 from first level key holder 220; and second level key_{B} 235, which is different from second level key_{A} 230, is derived for the same client by first level key holder 220 and distributed to second level key holder_{B} 245 from first level key holder 220. Second level key_{A} 230 and second level key_{B} 235 can be derived based on one or more of the following information:
First level key 225;
Unique identifier associated with second level key holder for authenticator (R1KH-ID, e.g., the BSSID associated with the access point);
Unique identifier associated with second level key holder for supplicant (S1KH-ID, e.g., the supplicant's MAC address); and
an input used to derive the second level security key (e.g., FT-R1 under IEEE 802.11r standard).

In some embodiments, the input used to derive the second level security key can be a fixed string input to a one-way hash function, such as a KDF-256 hash function. For example, PMK-R1 may be a hash result that is produced by a hash function performed on any combination of inputs such as PMK-R0, FT-R1, R1KH-ID, S1KH-ID, etc. More specifically, the second level security key can be calculated according to the following formula:

PMK-R1=KDF-256 (PMK-R0, “FT-R1”, R1KH-ID∥S1KH-ID)

Hence, first level key holder 220 stores first level key 225. Second level key holder_{A} 240 stores second level key_{A} 230; and second level key holder_{B} 245 stores second level key_{B} 235, respectively. In some embodiments, a secure channel is established between first level key holder 220 and each second level key holder 240 or 245 to directly exchange cryptographic keys without being exposed to any intermediate parties. The cryptographic strength of the secure channel is greater than or equal to the strength of the secure channels for which the exchanged cryptographic keys will be used.

Although only one first level key holder 220 is depicted in FIG. 2, it shall be noted that authentication server may provide MSK 204 (or PSK 206 may be configured on) to two or more first level key holders 220 in different mobility domains. Moreover, although two second level key holders are depicted in FIG. 2, a mobility domain may include more than two second level key holders, such as second level key holder_{A} 240 or second level key holder_{B} 245, or only one second level key holder.

In addition, second level key holders for authenticator and supplicant derive the derived keys (such as derived key_{A} 250 and derived key_{B} 255) in conjunction with each other. In some embodiments, derived keys are the third level keys in a fast BSS transition (FT) key hierarchy. In one embodiment, the derived keys are pairwise transient keys (PTKs). In some embodiments, the derived keys can be derived from one or more of the following information:
Second level key, such as second level key_{A} 230 or second level key_{B} 235;
A random number generated by an authenticator (e.g., ANonce);
A random number generated by a supplicant (e.g., SNonce);
A unique network identifier (e.g., the BSSID associated with the access point);
A unique client identifier (e.g., the wireless client station's MAC address); and
an input used to derive the derived security key (e.g., FT-PTK under IEEE 802.11r standard).

In some embodiments, the input used to derive the derived security key can be a fixed string input to a one-way hash function, such as a SHA256-based pseudo-random hash function (e.g., KDF-PTKLen hash function). For example, PTK may be a hash result that is produced by a hash function performed on any combination of inputs such as PMK-R1, FT-PTK, SNounce, ANounce, BSSID, Station address (STA-ADDR), etc. More specifically, the derived security can be calculated according to the following formula:

PTK=KDF-PTKLen (PMK-R1, “FT-PTK”, SNounce∥ANounce∥BSSID∥

### Fast Basic Service Set (BSS) Transition (FT) Mechanism

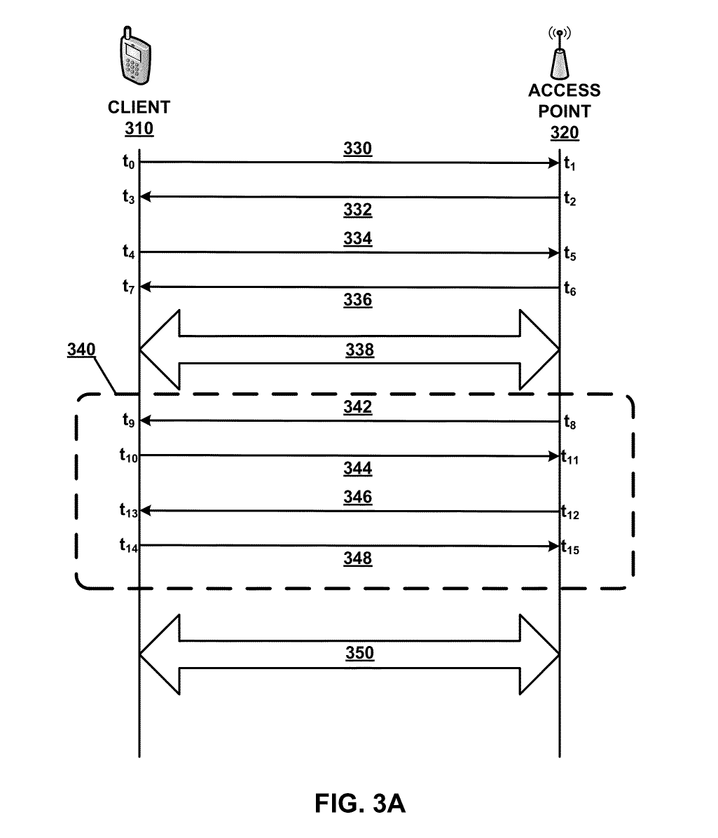

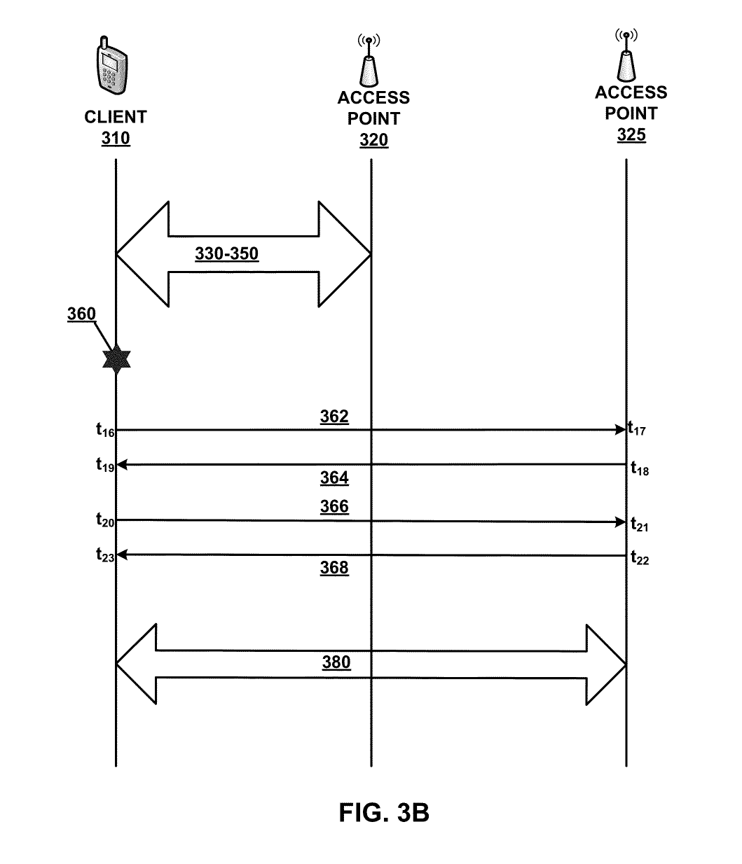

FIGS. 3A-3B illustrate exemplary communications exchanges during fast BSS transition. In a basic FT process, when a wireless station moves into the coverage of a mobility domain for the very first time, the wireless station will start interacting with the wireless network device (such as an access point), which is located in the closest proximity to the station. The wireless station will follow through an FT initial mobility domain association with the nearest access point. Thereafter, when the wireless station roams to a different access point, the wireless station will follow through an FT (re)association procedure with the new access point to reduce the overhead handoff time and improve data connectivity.

A. FT Initial Mobility Domain Association

FIG. 3A illustrates the FT initial mobility domain association (IMDA), which occurs when a wireless station associates with a nearest access point in a mobility domain for the first time without any prior association with any other access points in the same mobility domain. In the FT IMDA, the following frames and/or information will be exchanged:
management frames to complete the authentication process;
management frames to complete the association process;
authentication exchanges, such as IEEE 802.1x EAP authentication (note that this is bypassed if PSK is used); and/or
key exchanges, such as an EAPOL-Key handshake for key exchange.

Specifically, in the exemplary communication exchanges between client 310 and access point 320 in FIG. 3A, client 310 first initiating the FT IMDA by transmitting authentication request 330, such as an IEEE 802.11 authentication request, to the access point at time point t₀. After access point 320 receives authentication request 330 at time point t₁, access point 320 sends authentication response 332, e.g., an IEEE 802.11 authentication response, back to client 310 at time point t₂. In some embodiments, authentication request 330 and authentication response 332 both use Open System authentication mechanism in accordance with the IEEE 802.11r standard.

Next, upon successful authentication at time point t₃, client 310 will send association request 334 to access point 320 at time point t₄. According to some embodiments, association request 334 may include a Mobility Domain Information Element (MDIE) and a Robust Security Network Information Element (RSNIE) as specified in IEEE 802.11 standards. MDIE is included in association request 334 to indicate client 310's support for the FT procedures, whereas RSNIE is included in association request 334 to indicate client 310's security capabilities. Access point 320 can advertise the content of MDIE in its beacon or probe response frames.

Once association request 334 is received at access point 320 at time point t₅, access point 320 will send association response 336 at time point t₀; and association response 336 is received by client 310 at time point t₇. Note that, if the contents of MDIE do not match the contents advertised, or if the contents of RSNIE do not indicate a negotiated AKM suite of FT (such as, suite type 00-0F-AC:3 or 00-0E-AC:4), access point 320 will reject association request 334. In some embodiments, association response 336 may include a Mobility Domain Information Element (MDIE) with contents as presented in beacon and/or probe response frames, and a Fast BSS Transition Information Element (FTIE), as specified in IEEE 802.11. The FTIE may include, for example, a unique identifier associated with the first level key holder (e.g., R0KH-ID under IEEE 802.11r) and/or a unique identifier associated with the second level key holder (e.g., R1KH-ID under IEEE 802.11 r).

Upon successful association between client 310 and access point 320, the supplicant's first level key holder (e.g., S0KH) on client 310 and the authenticator's first level key holder (e.g., R0KH) on access point 320 or a network controller coupled to access point 320 will proceed to perform an authentication procedure 338 involving multiple communication exchanges in accordance with, e.g., IEEE 802.1X EAP authentication. Upon successful completion of authentication procedures 338 (e.g., IEEE 802.1X EAP authentication), the authenticator's first level key holder (R0KH) receives MSK and corresponding authorization attributes. If a key hierarchy already exists for client 320, the authenticator's first level key holder (R0KH) will delete existing first level and second level security keys, and re-calculate a new first level security key and a second level security key for client 310 using the received MSK. However, if PSK is used, the IEEE 802.1X EAP authentication procedure can be bypassed.

Next, the second level key holders for the supplicant and the authenticator perform an FT 4-way handshake 340. Specifically, at time point t₈, access point 320 (authenticator's second level key holder, R1KH) sends a first message 342, such as an EAPOL-Key frame including a random number generated by the authenticator (e.g., ANonce), to client 310 (supplicant's second level key holder, S1KH). Client 310 receives the first message 342 at time point t₉, and sends a second message 344 to access point 320 at time point t₁₀. The second message 344 can be an EAPOL-Key frame. In one embodiment, the EAPOL-Key frame of the second message 342 includes a random number generated by the supplicant (e.g., SNonce), and RSNIE which indicates the name of the second level security key (e.g., PMK-R1) calculated by the supplicant's second level key holder (S1KH) based on a pre-agreed-upon procedure. Thereafter, at time point t₁₁, access point 320 receives the second message 344 and sends a third message 346 to client 310 at time point t₁₂. In one embodiment, the third message 346 is an EAPOL-Key frame, which includes ANonce and the name of the second level security key (e.g., PMK-R1). This name in the third message 346 should be the same as the one received in the second message 344. After client 310 receives the third message 346 at time point t₁₃, client 310 sends a fourth message 348 back to access point 320 at time point t₁₄, and access point 320 receives the fourth message 348 at time point t₁₅. Note that the RSNIE fields, as well as the FTIE and MDIE, in the EAPOL-Key frames used in the 4-way handshake 340 shall be consistent among the first message 342, the second message 344, the third message 346, and the fourth message 348.

Finally, upon completion of the 4-way handshake 340, derived keys (e.g., PTKs) will be calculated for each specific <second level key holder, client> pair. Also, the IEEE 802.1X controlled port will be opened on both client 310 and access point 320. All subsequent communication exchanges 350 involving data transmissions between client 310 and access point 320 shall be protected by the derived key.

B. FT Roaming Within Mobility Domain

FIG. 3B illustrates exemplary communication exchanges during an FT roaming by client 310 from one access point 320 to another access point 325, which is located within the same mobility domain. In this example, client 310 has followed through communication exchanges 330-350, as described above in reference to FIG. 3A, with access point 350. Then, client 310 roams to a new location and decides 360 to initiate FT to another network device, such as access point 325.

In the communication exchanges between client 310 and access point 325, the following frames are exchanged in the following time sequence:
An authentication request 362, which is sent by client 310 at time point t₁₆ and received by access point 325 at time point t₁₇.
An authentication response 364, which is sent by access point 325 at time point t₁₈ after completing an authentication process, e.g., EAPOL, with an authentication server, and which is received by client 310 at time point t₁₉;
A re-association request 366, which is sent by client 310 at time point t₂₀ and received by access point 325 at time point t₂₁; and
A re-association response 368, which is sent by access point 325 at time point t₂₂ and received by client 310 at time point t₂₃.

The exchange of information through these communication exchanges between client 310 and access point 325 complete the association between client 310 and access point 325, and also complete derivation of the derived key (e.g., PTK). Thereafter, all subsequent communication exchanges 380 involving data transmissions between client 310 and access point 325, e.g., using EAPOL-Key frames, shall be protected by the derived key.

### Pro-Active Propagation of Leveled Security Keys

In order to derive the derived keys (such as, PTK), the new wireless network device or access point that a client roams to uses the second level security key (e.g., PMK-R1). As described above in reference to FIG. 2, the second level security key (e.g., PMK-R1) is generated by the first level security key holder (e.g., R0KH). Thus, the new wireless network device would need to receive the second level security key (e.g., PMK-R1) from the first level security key holder (e.g., R0KH).

In some embodiments, a network controller is the first level security key holder and an access point derives the second level security key. In such embodiments, the communication exchanges between the network controller and the access point will result in a delay in the completion of the FT protocol. Therefore, in these embodiments, the first level security key holder (R0KH) may pro-actively propagate the second level keys (PMK-R1) to other network devices in the neighborhood before a wireless station, which is an FT-capable client, initiates the FT to a new network device or access point.

Hence, the pro-active propagation mechanisms of leveled security key in accordance with the present disclosure accelerate the time required for completion of the Fast BSS Transition when a wireless station later seeks a BSS transition within the same mobility domain within the same ESS after initial mobility domain association, and reduce the duration of time that data connectivity is lost between the wireless station and the distribution system during the FT.

A. Pro-active Propagation Initiated By First Level Key Holder

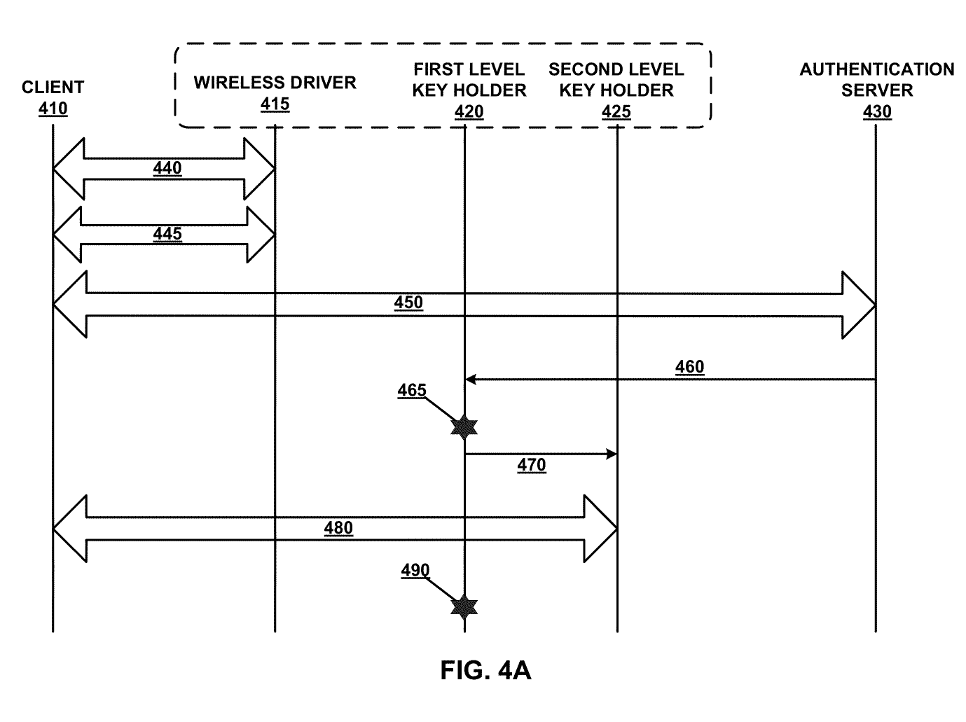

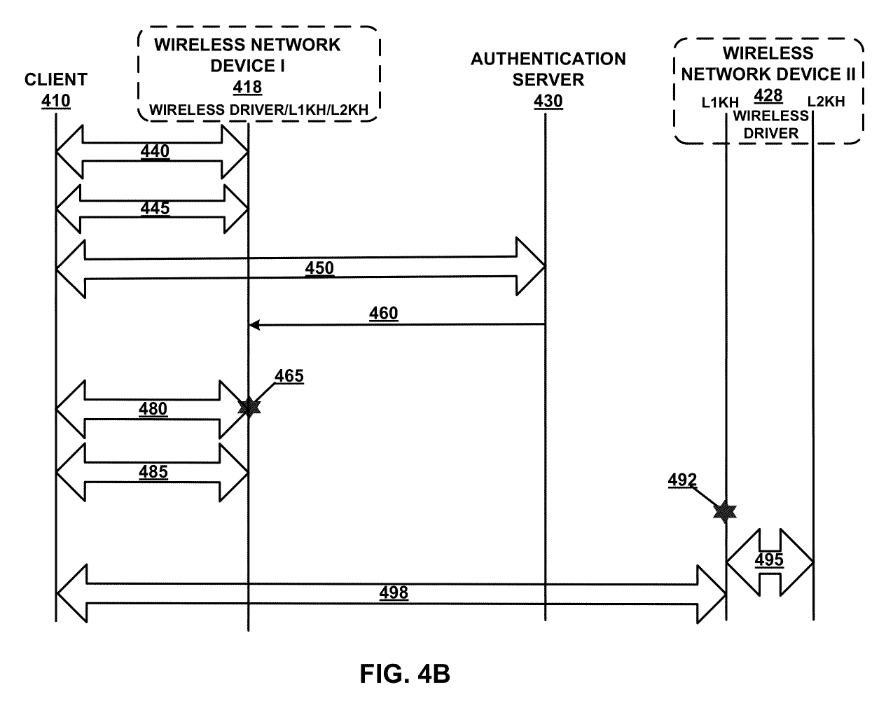

FIGS. 4A-4B are sequence diagrams illustrating exemplary communication exchanges during propagation of leveled security keys under fast BSS transition. In particular, FIG. 4A shows a pro-active leveled security propagation mechanism when the key propagation is initiated by a first level key holder in the key hierarchy. FIG. 4A includes at least client 410, wireless driver 415, first level key holder 420, second level key holder 425, and authentication server 430. During operations, client 410 first completes authentication communication exchanges 440, e.g., IEEE 802.11 authentication exchanges, with wireless driver 415. Then, client 410 completes association communication exchanges 445, e.g., IEEE 802.11 association exchanges, with wireless driver 415. Next, client 410 initiates 802.1x EAP authentication exchanges 450 to obtain MSK from authentication server 430 (this is bypassed if PSK is used). During this process, the MSK is obtained by the first level key holder 420 (e.g., R0KH) too as shown in communication exchange 460. The first level key holder 420 uses the information it has, including MSK or PSK, to derive a first level security key (e.g., PMK-R0) and the second level security keys (e.g., PMK-R1) as shown by operation 465. Note that each second level security key (e.g., PMK-R1) is associated with client 410 for a specific second level key holder 425 (e.g., R1KH) that client 410 could potentially roam to.

After first level key holder 420 (e.g., R0KH) derives the second level security keys (e.g., PMK-R1s), first level key holder 420 transmits the second level security key to its corresponding second level security key holder 425 (e.g., R1KH) as shown in communication 470. Client 410 completes a 4-way handshake 480 with second level security key holder 425 (e.g., R1KH) to derive the derived key (e.g., PTK) for client 410. In one embodiment, the second level security key is received by its corresponding second level security key holder 425 (e.g., R1KH) during the 4-way handshake 480 communications.

In some embodiments, the first level key holder (e.g., R0KH) can proactively propagate 490 the second level keys (e.g., PMK-R1) to a subset of second level key holders (e.g., R1KHs) prior to client 410 roams to any neighboring wireless network device, e.g., another second level key holder (not shown). Therefore, when client 410 eventually decides to initiate a BSS transition to a neighboring wireless network device (e.g., the other second level key holder), its second level security key (e.g., PMK-R1) for that particular second level key holder (not shown) and client 410 would have already been propagated and thus available to the other second level key holder of client 410. As such, the other second level key holder does not need to obtain second level key (e.g., PMK-R1) from first level key holder 420 (e.g., R0KH) when client 410 initiates the BSS transition to the other second level key holder. Accordingly, the pro-active propagation of leveled security keys would reduce the time it takes to complete the Fast BSS Transition (FT) protocol.

In the mechanism illustrated in FIG. 4A, the second level security keys (e.g., PMK-R1) need to be propagated only once for every wireless network device, e.g., second level key holder 425 or the other second level key holder, during the lifetime of client 410's association to the network. In some embodiments, the second level security key (e.g., PMK-R1) will get removed from the second level key holder 425 (e.g., R1KH) on expiry of the second level security key's lifetime, which is bound to the lifetime of the PSK or MSK. In some embodiments, the lifetime of the first level security key (e.g., PMK-R0), the second level security key (e.g., PMK-R1), the derived security key (e.g., PTK) are the same as the lifetime of the PSK or MSK. In other embodiments, the second level security key (e.g., PMK-R1) will be removed from the second level key holder 425 (e.g., R1KH) when client 410 initiates another IMDA, or based on when client 410 is no longer associated with the network. For example, client 410 may be regarded as no longer associated with the network when client 410 disassociates with, or de-authenticates from the network, or when client 410 is associated with a longer period of inactivity than a predetermined threshold length.

B. Pro-active Propagation Initiated By Second Level Key Holder

FIG. 4B shows a pro-active leveled security propagation mechanism when the key propagation is initiated by a second level key holder in the key hierarchy. Specifically, a second level key holder (e.g., R1KH) can initiate the process for pro-actively obtaining the second level security key (e.g., PMK-R1) for a particular IEEE 802.11r client from the first level key holder (e.g., R0KH).

FIG. 4B includes at least client 410, wireless network device I 418 (which includes both a first level key holder L1KH and a second level key holder L2KH for client 410), wireless network device II 428 (which is associated with both a first level key holder L1KH and a second level key holder L2KH for client 410), and authentication server 430. During operations, client 410 first completes authentication communication exchanges 440, e.g., IEEE 802.11 authentication exchanges, with wireless network device I 418. Then, client 410 completes association communication exchanges 445, e.g., IEEE 802.11 association exchanges, with wireless network device I 418. Subsequently, client 410 completes EAPOL communication exchanges 450 to obtain MSK from authentication server 430 (this is bypassed if PSK is used). During this process, the MSK is also obtained by first level key holder L1KH present within wireless network device I 418 as shown by communication exchange 460. Next, wireless client device I 418 uses the information it has, including MSK or PSK, to derive a first level security key (e.g., PMK-R0) and the second level security keys (e.g., PMK-R1) as shown by operation 465. Note that each second level security key (e.g., PMK-R1) is associated with client 410 for a specific second level key holder (e.g., L2KH) that client 410 could potentially roam to. Also, client 410 completes a 4-way handshake 480 with wireless network device I 418 to derive a derived key (e.g., PTK). In one embodiment, the first level security key (or the second level security key) is received by the first level key holder (or second level key holder) during the 4-way handshake communication period as shown by operation 480. Thereafter, client 410 can use the derived security key to start secured data transmission with wireless network device I 418 as shown by operation 485.

In some embodiments, each wireless client may periodically scan its networking environment to determine whether there is a better connectivity available to the wireless client through a different wireless network device, such as a different access point from the access point that the wireless client is currently associated with.

In some embodiments, the scanning process can increase its purposefulness and frequency when wireless client 410 determines that the signal strength from wireless network device I 418 (e.g., an access point), with which wireless client 410 is currently associated, has been weakened to a level that is below a predetermined threshold. The signal strength from wireless network device I 418 may be weakened, for example, when wireless client 410 changes to a new location where wireless network device I 418 has poor coverage. In such cases, client 410 sends out connection request frames to wireless network devices (e.g., wireless network device II 428) whose signal strength is much better than the signal strength of wireless network device I 418 that is currently serving client 410.

Each wireless network device (e.g., wireless network device II 428) in the neighborhood of client 410 listens to connection requests, such as probe requests, association requests, authentication requests, etc., from client 410. In some embodiments, if the number of probe requests received from wireless client 410 within a particular duration exceeds a predetermined threshold limit, wireless network device II 428 will deem that there is a strong possibility that client 410 could initiate a Fast BSS Transition (FT) procedure to wireless network device II 428. Hence, second level key holder (L2KH) within wireless network device II 428 will initiate process 495 to obtain the second level security key (e.g., PMK-R1) from the first level key holder (L1KH) for wireless client 410. When the first level key holder (L1KH) at wireless network device II 428 hears connection requests 492 from client 410, L1KH may propagate 495 the second level security key (e.g., PMK-R1) to wireless network device II 428 after receiving requests from L2KH. Note that, typically, when key propagation happens after L1KH at wireless network device II 428 receives a connection request from wireless client 410, the first level key holder L1KH will only send the second level key (e.g., PMK-R1) corresponding to the particular second level key holder that initiates the propagation, e.g., L2KH at wireless network device II 428. Hence, only one second level security key will be sent from the first level key holder to the second level key holder.

In this way, the second level security key (e.g., PMK-R1) for wireless client 410 would become available to the second level key holder (L2KH) within wireless network device II 428, prior to client 410 initiating the FT process with wireless network device II 428. Thus, there would be no need to obtain the second level security from the first level security key holder after client 410 initiating the FT process with wireless network device II 428. This would reduce the time it takes to complete the Fast BSS Transition (FT) protocol.

C. Pro-active Propagation Based on Neighborhood List

In a large network involving many wireless network devices, it becomes important to determine a subset of these wireless network devices that would be involved in the propagation of the second level security keys (e.g., PMK-R1s) for a wireless client station. In some embodiments, the first level security key holder (e.g., R0KH) can pro-actively propagate the second level security keys (e.g., PMK-R1s) to other wireless network devices (e.g., R1KHs) based on a neighborhood list associated with the client.

For example, in some embodiments, each wireless network device may have a list of its closest neighbors. This list can be utilized to determine the subset of wireless network devices to which the second level security keys (e.g., PMK-R1s) for the wireless client will be pro-actively propagated.

D. Pro-active Propagation Based on Client Roaming Map

In some embodiments, the determination of the subset of wireless network devices to which the second level security keys will be pro-actively propagated can be made based on the mobility patterns of the wireless client and/or the radio frequency statistics.

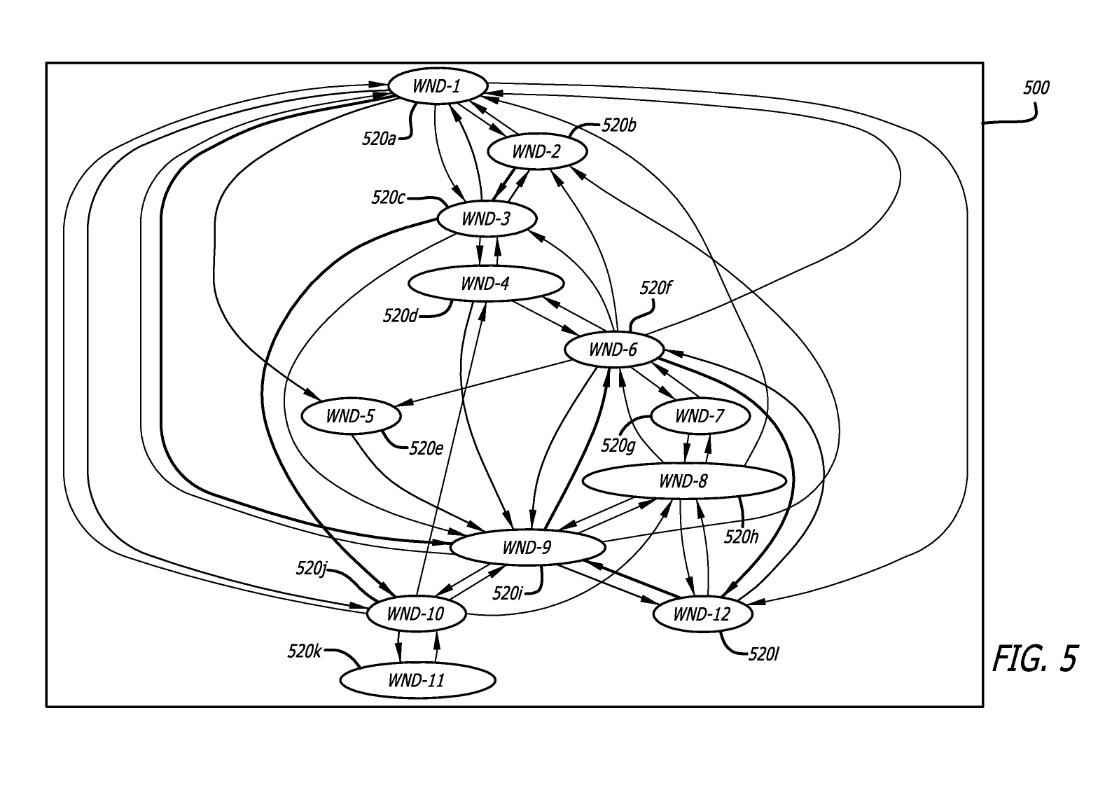

For example, in one embodiment, the network can generate a roaming map of a specific wireless client as illustrated in FIG. 5. FIG. 5 shows network 500, which includes wireless network devices 520a-520l. Wireless network devices 520a-520l can include, but are not limited to, a network controller, an access point, a switch, a router, etc. In some embodiments, each of wireless network devices 520a-520l represents a network device that the wireless client has been associated with in the past (e.g., within a predetermined time period during the past). In other embodiments, each of wireless network devices 520a-520l represents a network device that the wireless client is likely to be associated with in the future (e.g., based on the client's profile information, roaming pattern collected from similar clients, etc.).

In some embodiments, the arrows between network devices 520a-520l indicate the likelihood of the wireless client to roam from a first network device to a second network device. In one embodiment, the darkness/thickness of the arrow is proportional to the likelihood of the wireless client roaming from a first node where the arrow starts to a second node where the arrow points to or ends at. As an example, the arrow pointing from network device 520f to network device 520l is thicker and darker than the arrow pointing from network device 520f to network device 520g. Therefore, according to the illustrated example in FIG. 5, the wireless client has a higher probability of roaming from network device WND-6 520f to network device WND-9 520i than to network device WND-7 520g.

In some embodiments, the subset of wireless network devices in a roaming map corresponding to the darkest arrows from the wireless network device, with which the wireless client is currently associated, is determined to be the subset of wireless network devices to which the second level security keys (e.g., PMK-R1s) will be pro-actively propagated for the wireless client prior to the wireless client actually roams to any of the neighborhood wireless network devices.

### Leveled Security Key Propagation Process

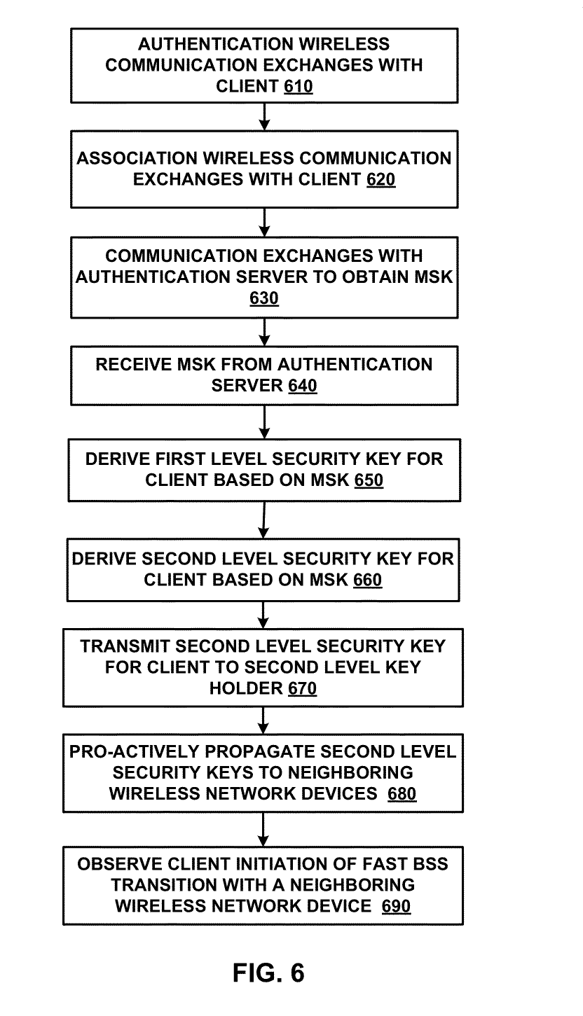

FIG. 6 is a flowchart illustrating a process for pro-active propagation of leveled security keys according to embodiments of the present disclosure. During operations, the disclosed wireless network device first completes a set of wireless authentication communication exchanges, e.g., exchanges of IEEE 802.11 authentication frames, with a wireless client (operation 610). Next, the wireless network device completes a set of wireless association communication exchanges, e.g., exchanges of IEEE 802.11 association frames, with the wireless client (operation 620). Then, the disclosed wireless network device, acting as an authenticator, completes authentication process with an authentication server, e.g., EAPOL message exchanges with a RADIUS server (operation 630).

Subsequent to the authentication process with the authentication server, the wireless network device receives a master key, such as MSK, associated with the wireless client (operation 640) (this is bypassed if PSK is used). The wireless network device then derives a first level security key based on the received master key (e.g., MSK or PSK) (operation 650). Next, the wireless network device derives a second level security key based on the received master key (e.g., MSK or PSK) (operation 660). Note that the second level security key is specific to each combination or pair of the client and the second level key holder.

Thereafter, the wireless network device transmits the derived second level security key to the second level security key holder (operation 670). Moreover, the wireless network device determines a subset of neighborhood wireless network devices that the wireless client is likely to roam to at a future time point, derives second level security keys for those neighboring wireless network devices, and pro-actively propagates the derived second level security keys to the neighboring wireless network devices (operation 680). Also, the wireless network device may observe the wireless client to initiate a Fast BSS Transition (FT) to a different wireless network device in the neighborhood after the pro-active propagation of the second level security to the different wireless network device (operation 690). Note that, according to embodiments of the present disclosure, the wireless network device anticipates the wireless client to roam to one or more different wireless network devices in the neighborhood, and propagates the second level security keys to the neighboring wireless network devices prior to observing the wireless client to initiate a Fast BSS Transition (FT) to a neighboring wireless network.

### Leveled Security Key Propagation System

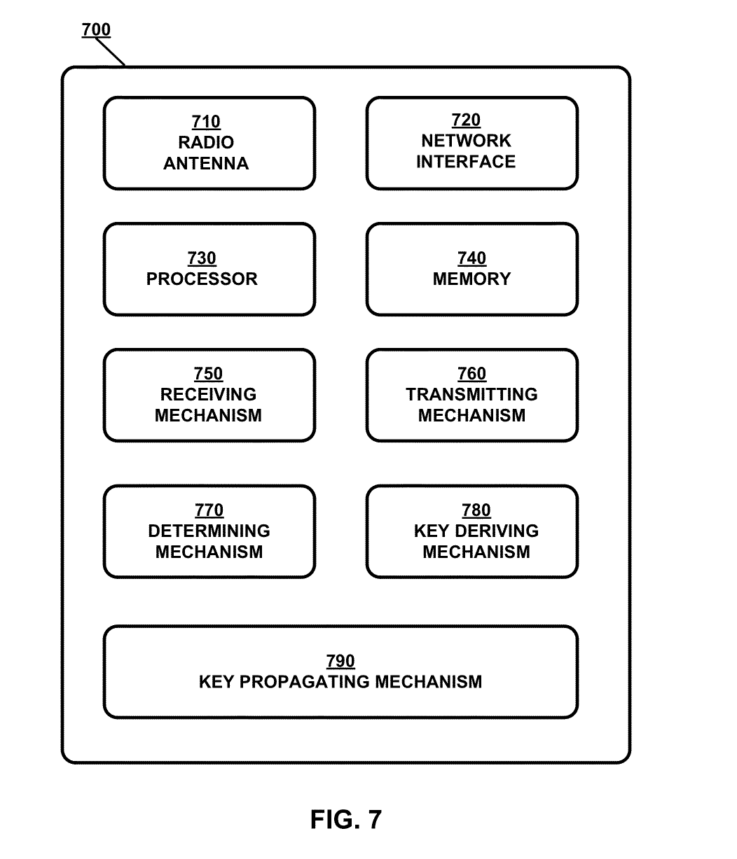

FIG. 7 is a block diagram illustrating a system for pro-active propagation of leveled security keys according to embodiments of the present disclosure.

Operating as a node in a wireless digital network, network device 700 includes at least one or more radio antennas 710 capable of either transmitting or receiving radio signals or both, a network interface 720 capable of communicating to a wired or wireless network, a processor 730 capable of processing computing instructions, and a memory 740 capable of storing instructions and data. Moreover, network device 700 further includes a receiving mechanism 750, a transmitting mechanism 760, an assigning mechanism 770, and a detecting mechanism 780, all of which are coupled to processor 730 and memory 740 in network device 700. Network device 700 may be used as a client system, or a server system, or may serve both as a client and a server in a distributed or a cloud computing environment.

Radio antenna 710 may be any combination of known or conventional electrical components for receipt of signaling, including but not limited to, transistors, capacitors, resistors, multiplexers, wiring, registers, diodes or any other electrical components known or later become known.

Network interface 720 can be any communication interface, which includes but is not limited to, a modem, token ring interface, Ethernet interface, wireless IEEE 802.11 interface, cellular wireless interface, satellite transmission interface, or any other interface for coupling network devices.

Processor 730 can include one or more microprocessors and/or network processors. Memory 740 can include storage components, such as, Dynamic Random Access Memory (DRAM), Static Random Access Memory (SRAM), etc.

Receiving mechanism 750 receives one or more network messages via network interface 720 or radio antenna 710 from a wireless client. The received network messages may include, but are not limited to, requests and/or responses, beacon frames, management frames, control path frames, and so on. Each message may comprise one or more data packets, for example, in the form of IP packets. In some embodiments, receiving mechanism 750 receives a master key associated with a wireless client from an authentication server such as a RADIUS server.

Transmitting mechanism 760 transmits messages, which include, but are not limited to, requests and/or responses, beacon frames, management frames, control path frames, and so on. In some embodiments, receiving mechanism 750 and transmitting mechanism 760 in conjunction with each other perform four-way handshake communication exchanges to derive a derived key for the wireless client. Furthermore, transmitting mechanism 760 transmits the derived key to the wireless client, and uses the derived key in subsequent data transmissions with the wireless client.

Determining mechanism 770, according to embodiments of the present disclosure, determines a subset of network devices in the neighborhood of the wireless client. In some embodiments, determining mechanism 770 determines whether a network device exists in a neighborhood list indicating closest neighboring network devices to the wireless client. In response to the network device existing in the neighborhood list, determining mechanism 770 will include the network device in the subset; otherwise, determining mechanism 770 will not include the network device in the subset. In other embodiments, determining mechanism 770 determines whether the wireless client is likely to roam to a network device based on the degree of likelihood indicated on a roaming map of the wireless client. The roaming map represents a dynamically determined roaming pattern of the wireless client. In an exemplary roaming map, each node corresponds to a network device that the wireless client may potentially roam to, the arches and/or arrows between the nodes indicate the potential direction that the wireless client may roam towards, and the degree of darkness/thickness of each arch/arrow indicates the likelihood of the wireless client to roam from the starting node of the arch/arrow to the ending node of the arch/arrow. The roaming map can be based on either past observed roaming activities, or future predicted roaming patterns, or a combination of both. In one embodiment, determining mechanism 770 includes a specific network device in the subset in response to the degree of likelihood of the wireless client roaming to the specific network device being greater than a predetermined threshold. In some embodiments, the roaming map may be generated based on exchange of radio measurement information between a wireless client device and a network device, such as an access point.

Key deriving mechanism 780 generally derives leveled security keys for the wireless client. For example, key deriving mechanism 780 can derive a first level security key for the client from the received master key. As another example, key deriving mechanism 780 can derive one or more second level security keys for the wireless client. Each second level security key corresponds to one of the network devices in the subset of neighborhood network devices. In some embodiments, the second level security key is derived based on one or more of the following: (i) the first level security key; (ii) a unique identifier associated with the corresponding second level key holder for the network device; and/or (iii) a unique identifier associated with the second level key holder for the wireless client.

Key propagating mechanism 790 generally propagates one or more security keys derived from the master key to the subset of the network devices prior to the wireless client associates with any network device in the subset. In some embodiments, the one or more security keys represent one or more derived second level security keys corresponding to each network device in the subset of the neighborhood network devices.

In some embodiments, propagation of the one or more security keys is initiated by a first level key holder. In other embodiments, propagation of the one or more security keys is initiated by a second level key holder. In particular, according to one embodiment, propagating the one or more security keys is initiated by the second level key holder in response to receiving a connection request, such as a probe request, an association request, an authentication request, etc., from the wireless client, for example, when the wireless client observes weakened wireless signal strength from the network device that the wireless client is currently associated with.

In some embodiments, the first level security key, the second level security key, and the derived key for the wireless client expire when the master key for the wireless client expires.

Receiving mechanism 750, transmitting mechanism 760, determining mechanism 770, key deriving mechanism 780, and key propagating mechanism 790 collectively operate with each other to accomplish pro-active propagation of leveled security keys. For example, transmitting mechanism 760 may transmit the first level security key derived by key driving mechanism 780 to a first level key holder that stores the first level security key. Moreover, transmitting mechanism 760 may also transmit each second level security key to a corresponding second level key holder in the subset that stores the second level security key.

According to embodiments of the present disclosure, network services provided by wireless network device 700, solely or in combination with other wireless network devices, include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A method comprising:
determining, by a wireless network device, a subset of wireless network devices in the neighborhood of a wireless client; and
propagating, by the wireless network device, one or more security keys derived from a master key to the subset of the wireless network devices prior to the wireless client initiating a transition to another wireless network device in the subset of wireless network devices.

2. The method of claim 1, further comprising:
performing, by the wireless network device, a four-way handshake communication exchange to derive a derived key for the wireless client; and
using, by the wireless network device, the derived key in subsequent data transmissions with the wireless client.

3. The method of claim 1, further comprising:
deriving, by the wireless network device, a first level security key; and
transmitting, by the wireless network device, the first level security key to a first level key holder that stores the first level security key.

4. The method of claim 3,
further comprising deriving one or more second level security keys for the wireless client, wherein each second level security key corresponds to one wireless network device in the subset of wireless network devices; and
wherein propagating the one or more security keys derived from the master key comprises transmitting each second level security key to a corresponding second level key holder in the subset of wireless network devices that stores the second level security key.

5. The method of claim 4, wherein the second level security key is derived based on one or more of the following:
the first level security key;
a unique identifier associated with the corresponding second level key holder for the wireless network device;
a unique identifier associated with the second level key holder for the wireless client; and
a hash input used to derive the second level security key.

6. The method of claim 4, wherein propagating the one or more security keys is initiated by one of the first level key holder and the second level key holder.

7. The method of claim 4, wherein the first level security key, the second level security key, and the derived key for the wireless client expire when the master key for the wireless client expires.

8. The method of claim 6, wherein propagating the one or more security keys is initiated by the second level key holder in response to receiving a connection request from the wireless client.

9. The method of claim 1, wherein determining the subset of wireless network devices comprises determining whether a network device exists in a neighborhood list indicating closest neighboring wireless network devices to the wireless client.

10. The method of claim 1, wherein determining the subset of wireless network devices comprises determining whether the wireless client is likely to roam to a wireless network device based on the degree of likelihood indicated on a roaming map of the wireless client.

11. A wireless network device comprising:
a processor;
a memory;
a determining mechanism operating with the processor, the determining mechanism to determine a subset of wireless network devices in a neighborhood of the wireless client; and
a key propagating mechanism operating with the processor, the key propagating mechanism to propagate one or more security keys derived from a master key to the subset of the wireless network devices prior to the wireless client initiating a transition to another wireless network device in the subset of wireless network devices.

12. The wireless network device of claim 11, further comprising:
a transmitting mechanism operating with the processor, the transmitting mechanism to:
perform a four-way handshake communication exchange to derive a derived key for the wireless client; and
use the derived key in subsequent data transmissions with the wireless client.

13. The wireless network device of claim 11,
further comprising a key deriving mechanism operating with the processor, the key deriving mechanism to derive a first level security key; and
wherein the transmitting mechanism to transmit the first level security key to a first level key holder that stores the first level security key.

14. The wireless network device of claim 13,
wherein the key deriving mechanism to derive one or more second level security keys for the wireless client, wherein each second level security key corresponds to one of the wireless network devices in the subset of wireless network devices; and
wherein the transmitting mechanism to transmit each second level security key to a corresponding second level key holder in the subset of wireless network devices that stores the second level security key.

15. The wireless network device of claim 14, wherein the second level security key is derived based on one or more of the following:
the first level security key;
a unique identifier associated with the corresponding second level key holder for the wireless network device;
a unique identifier associated with the second level key holder for the wireless client; and
a hash input used to derive the second level security key.

16. The wireless network device of claim 14, wherein propagating the one or more security keys is initiated by one of the first level key holder and the second level key holder.

17. The wireless network device of claim 14, wherein the first level security key, the second level security key, and the derived key for the wireless client expire when the master key for the wireless client expires.

18. The wireless network device of claim 16, wherein propagating the one or more security keys is initiated by the second level key holder in response to receiving a connection request from the wireless client.

19. The wireless network device of claim 11, wherein the determining mechanism further determines whether a network device exists in a neighborhood list indicating closest neighboring wireless network devices to the wireless client.

20. The wireless network device of claim 11, wherein the determining mechanism further determines whether the wireless client is likely to roam to a wireless network device based on the degree of likelihood indicated on a roaming map of the wireless client.

21. A non-transitory computer-readable storage medium storing embedded instructions that are executed by one or more mechanisms implemented within a network device to perform a plurality of operations comprising:
determining a subset of wireless network devices in the neighborhood of a wireless client; and
propagating one or more security keys derived from a master key to the subset of the wireless network devices prior to the wireless client initiating a transition to another wireless network device in the subset of the wireless network devices.
